(19) United States
(12) Patent Application Publication
(10) Pub. No.: US 2025/0047734 A1
(43) Pub. Date: Feb. 6, 2025

(54) Network Selection Via Telephony Node

(71) Applicant: Zoom Video Communications, Inc., San Jose, CA (US)

(72) Inventor: Michael Garrett, Spring, TX (US)

(21) Appl. No.: 18/362,162

(22) Filed: Jul. 31, 2023

(51) Int. Cl. H04L 65/80; H04L 65/1069; H04L 65/1089; H04L 65/1104

(52) U.S. Cl. CPC H04L 65/80; H04L 65/1069; H04L 65/1089; H04L 65/1104

(57) ABSTRACT

A telephony node determines whether a session initiation request is associated with audio or video communication with an external station. The telephony node determines a session type for a session based on whether the session initiation request is associated with the audio or video communication with the external station, the session type comprising at least one of a public switched telephone network session or a Voice over Internet Protocol session. The telephony node causes initiation of the session based on the determination of the session type.

### FIELD

This disclosure relates to network selection via a telephony node. A telephony node may select a network for processing a session, for example, a video calling session or a telephony session.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of a first example telephone and video calling system.

FIG. 5 is a block diagram of a second example telephone and video calling system.

FIG. 6 is a block diagram of an example video calling system.

FIG. 7 is a flowchart of an example of a technique for network selection via telephony node.

FIG. 8 is a flowchart of an example of a technique for determining whether a destination station is an internal station or an external station.

### DETAILED DESCRIPTION

During the last decade, entities (e.g., businesses) have increasingly adopted Unified Communications as a Service (UCaaS) systems that incorporate Voice over Internet Protocol (VOIP) solutions for intra-premises communication, communication between premises of the same entity, and external communication. However, some jurisdictions (e.g., India) require the use of the public switched telephone network (PSTN) for external communication (e.g., to allow PSTN operators to collect a toll for the communication), while allowing the use of VOIP telephony for intra-premises communication or communication between premises of the same entity. Also, some companies may prefer using the PSTN to VOIP for some communications, for example, to improve audio quality in those communications in situations where the PSTN audio quality exceeds the VOIP audio quality and/or to allow the PSTN operators to collect the toll for the communication. Some companies leverage on-premises telephony nodes to facilitate audio and video communications using VoIP. Techniques for adapting the on-premises telephony node to allow for PSTN use for audio communications or for the audio portion of video communications may be desirable, for example, to allow for the use of the on-premises nodes in the jurisdictions that mandate PSTN usage or for entities that prefer PSTN usage.

Implementations of this disclosure accordingly address problems such as those described above by coupling an on-premises telephony node, which is configured to handle audio and video communications, with an on-premises session border controller (SBC), which handles PSTN communications and processes certain audio communications (e.g., as required by the jurisdiction) via the PSTN. The on-premises SBC stores a call detail record (CDR) to document audio communications handled via the PSTN and provide evidence of compliance with PSTN communication requirements or best practices. The on-premises telephony node receives a session initiation request (e.g., in response to an on-premises device initiating a video communication session or an audio communication session). The on-premises telephony node determines whether the session initiation request is associated with audio communication or video communication with an external station (e.g., a station that is not on the premises and not on another premises associated with an entity that owns or leases the premises).

If the session initiation request is associated with the audio communication or the video communication with the external station, the on-premises SBC generates a PSTN connection to the station for audio communication. If the session initiation request is associated with the video communication with the external station, the PSTN connection is used for the audio component of the video communication, and the on-premises telephony node creates an Internet-based video connection for the visual component of the video communication (as the PSTN connection might not be configured to process the visual component). If the session initiation request is not associated with the audio communication or the video communication with the external station, the on-premises telephony node initiates a VOIP session corresponding to the session initiation request.

As a result of some implementations, for video communications, visual data is transmitted over the Internet. For audio communications or the audio portion of video communications, communications to internal stations are processed over the Internet (e.g., using VOIP) while communications to external stations are processed over the PSTN. Internal stations include other stations on the same premises as the station initiating the session or other stations on other premises of the same entity (e.g., other offices of the same business). External stations include stations outside the premises and outside other premises of the entity. For example, if a user in the New York office of ABC Law Firm telephones a user in the Chicago office of ABC Law Firm, the call would be processed via VOIP, and the destination station would be an on-premises telephony node of the Chicago office. However, if the user in the New York office of ABC Law Firm telephones a business in Chicago that is different from the ABC Law Firm, that call would be processed via the PSTN, and the destination station would be a PSTN station in Chicago. If the user in the New York office of ABC Law Firm initiates a video call to a mobile device user located in Chicago (and having a Chicago telephone number) outside Chicago office of the ABC Law Firm, imagery of the video call would be transmitted over the Internet and audio of the video call would be transmitted over the PSTN, via a destination station associated with the mobile network operator in Chicago.

As used herein, the term “station” refers to a processing point or an end point for telephony or video call communications. A station may be a device associated with a telephone number or a device at which a telephone call or a video call may be placed or received. A station may be an end-user device, such as a mobile phone, a phone connected to a wired telephone network (e.g., the PSTN or an internal phone network of a premises), or a computing device running video calling software.

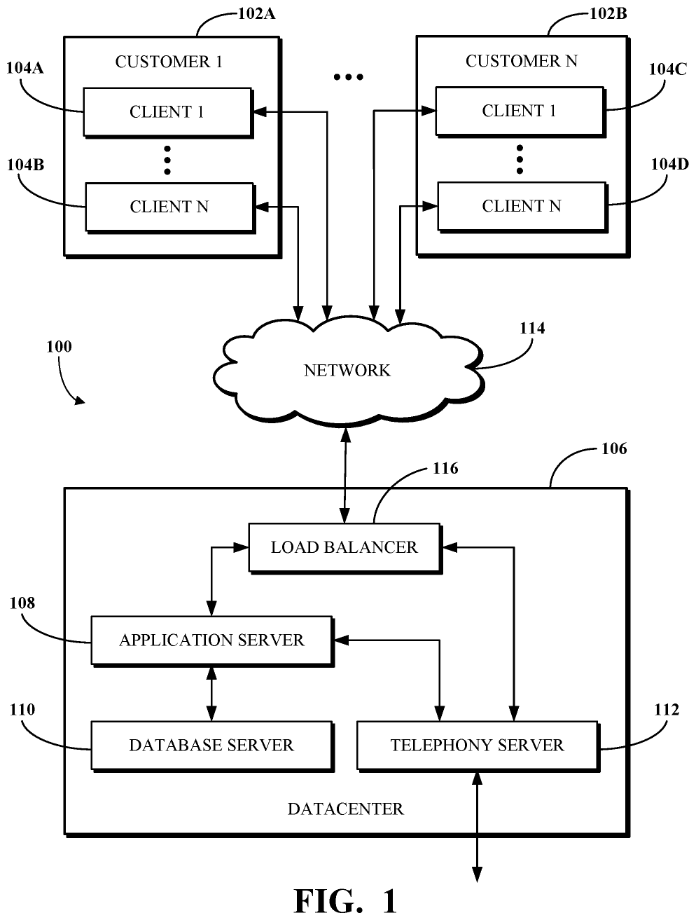

To describe some implementations in greater detail, reference is first made to examples of hardware and software structures used to implement network selection via telephony node. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be VoIP-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VoIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a PSTN system for outbound communication to the non-VoIP-enabled client or non-client phone. Hence, the telephony server 112 may include a PSTN system and may in some cases access an external PSTN system.

The telephony server 112 includes one or more SBCs for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

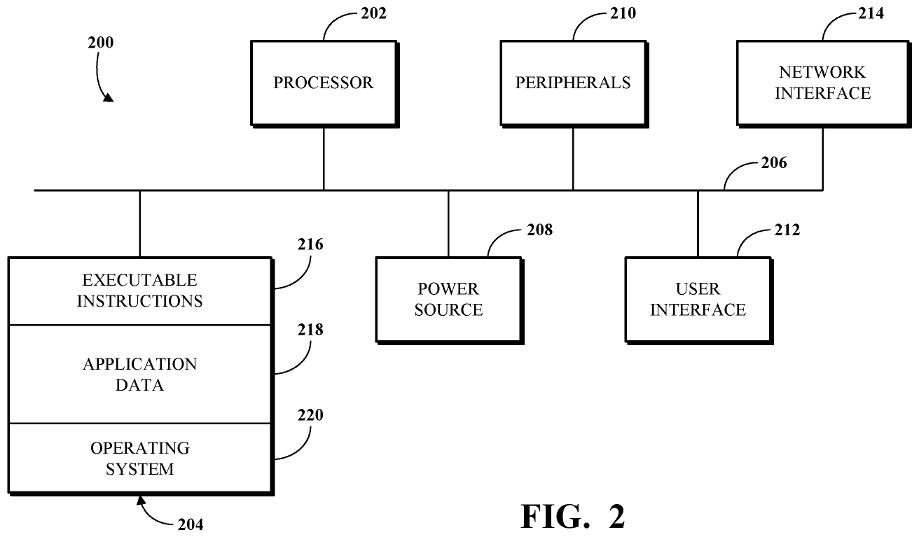

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

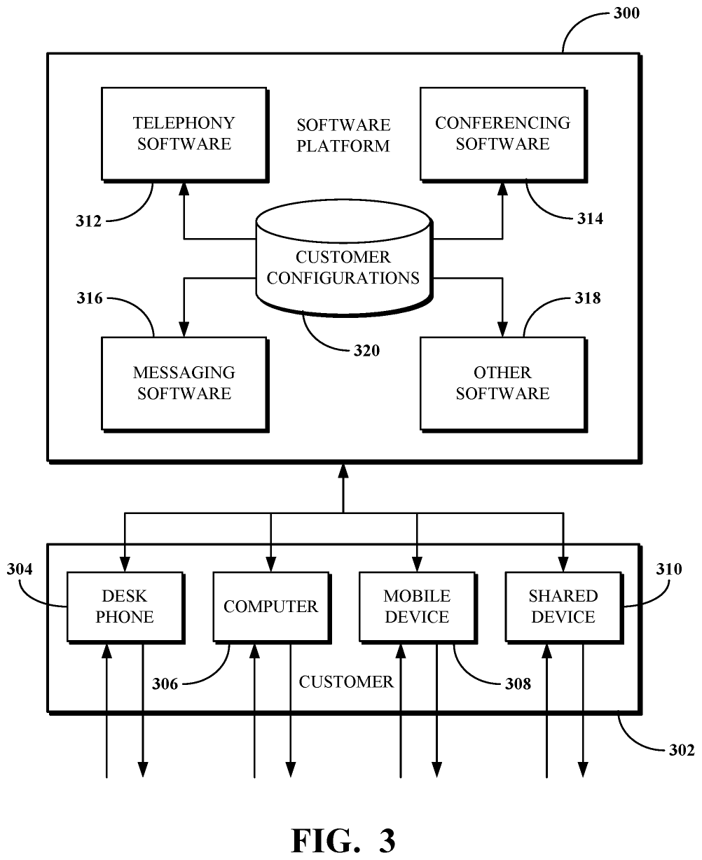

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VoIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software usable to perform network selection via a telephony node.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

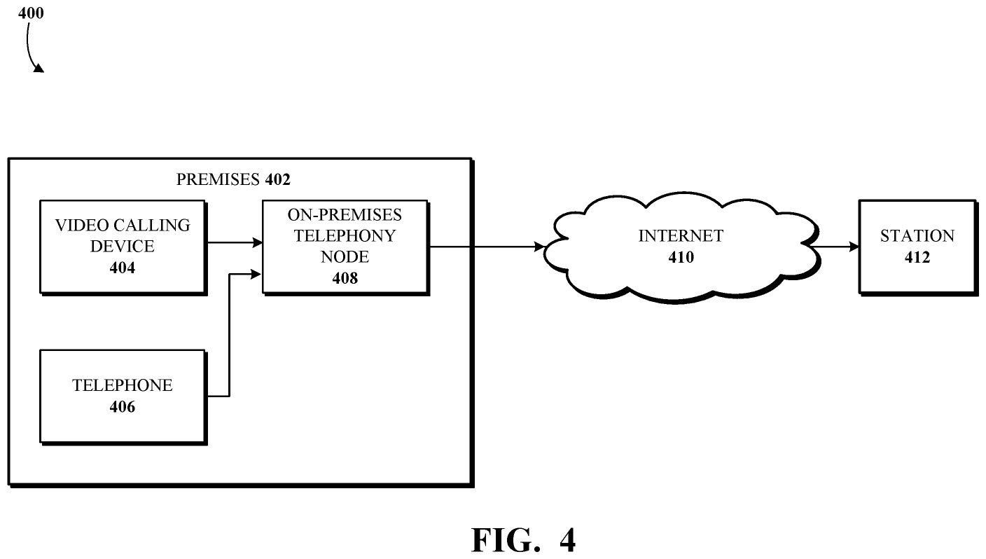

FIG. 4 is a block diagram of a first example telephone and video calling system 400. As shown, the system 400 includes a premises 202. The premises 202 may be any premises that subscribes to a telephony or video calling service. For example, the premises may be an office of a business, an office of a non-business organization, or a residence.

The premises 402 includes a video calling device 404, a telephone 406, and an on-premises telephony node 408. The video calling device 404 may be a computing device capable of performing video calls and connected to the on-premises telephony node 408 via a local network of the premises 402. For example, the video calling device 404 may be a laptop computer, a desktop computer, a mobile phone, or a tablet computer. The video calling device 404 may include at least one of processing circuitry, a memory subsystem, a network interface, a camera, a microphone, or a speaker. The video calling device 404 may, for example, correspond to one of the clients 104A-D or 304-310.

The telephone 406 may be VoIP or PSTN telephone connected (e.g., via a wired or wireless connection) to the on-premises telephony node 408. The telephone 406 may be a desk phone or a mobile phone that is configured to make and receive telephone calls over a telephone network via the on-premises telephony node 408. The telephone 406 may correspond to the desk phone 304 or the mobile device 308. While a single video calling device 404 and a single telephone 406 are illustrated, the premises 402 may include multiple video calling devices or multiple telephones.

The on-premises telephony node 408 is configured to process voice or video calls to or from devices on the premises 402 (e.g., the video calling device 404 or the telephone 406). Internal calls (from a device on the premises 402 to another device on the premises 402) may be processed directly by the on-premises telephony node 408 without reliance on any external networks. Thus, internal call may still be processed when the external networks are not available.

As shown, the on-premises telephony node 408 is connected to the Internet 410, and a station 412 located outside the premises is connected to the Internet 410. As a result, the on-premises telephony node 408 is capable of processing a VOIP call from a device on the premises 402 to the station 412 via the Internet 410. Also, a call originating at the station 412 may be connected to the device on the premises 402 via the on-premises telephony node 408.

As illustrated, the premises 402 has a single on-premises telephony node 408. However, in some cases, a premises may have multiple on-premises telephony nodes. For example, a large premises (e.g., a university campus) may have multiple telephony nodes located in different part of the premises to reduce contention for the telephony nodes and/or to reduce the distance between each on-premises device and its assigned on-premises telephony node.

The on-premises telephony node 408 performs registration functions to add devices (e.g., the video calling device 404 or the telephone 406) to the telephony plan of the premises. To register a device to be able to communicate via the on-premises telephony node 408, the device transmits a registration signal (including appropriate authentication information, such as a user identifier and a password) to the on-premises telephony node 408. The on-premises telephony node 408 then uses the Internet 410 to communicate with a data center (not shown) to register the device.

One drawback of the system 400 is that all calls to stations outside the premises 402 are processed via the Internet 410. As described above, some entities may wish to have some calls processed via the PSTN in order to comply with legal or best practice requirements. Techniques for leveraging the on-premises telephony node 408 to process certain calls via the PSTN may be desirable.

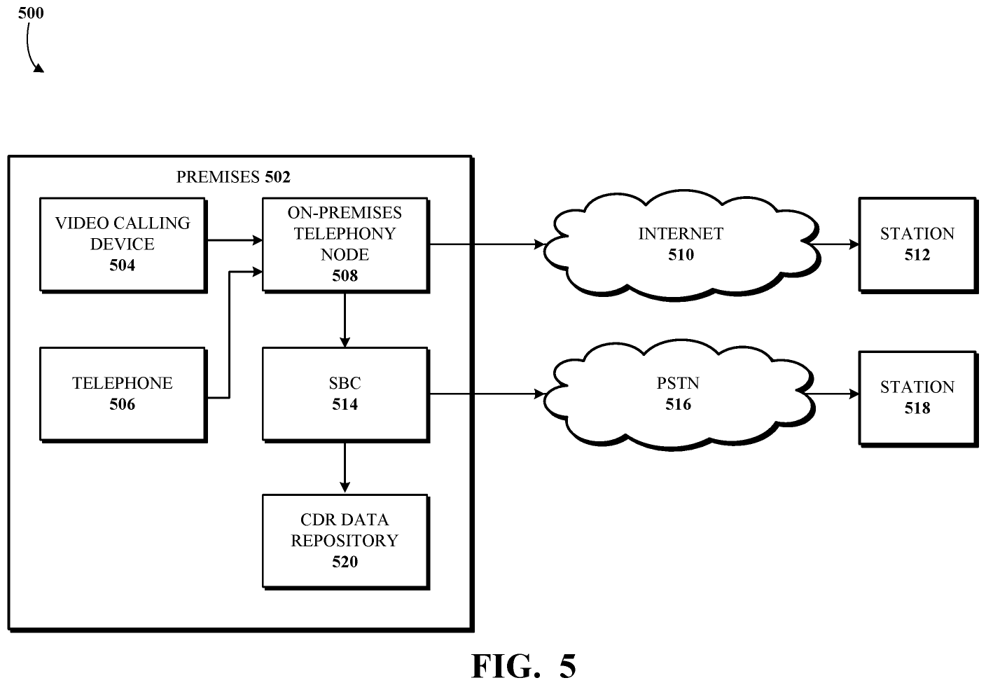

FIG. 5 is a block diagram of a second example telephone and video calling system 500. As shown, the system 500 includes a premises 502 (corresponding to the premises 402), which includes a video calling device 504 (corresponding to the video calling device 404), a telephone 506 (corresponding to the telephone 406), and an on-premises telephony node 508 (corresponding to the on-premises telephony node 408). The on-premises telephony node 508 connects calls from the video calling device 504 and/or the telephone 506, via the Internet 510 (e.g., corresponding to the Internet 410), to a station 512 (e.g., corresponding to the station 412) outside the premises 502. Alternatively, the on-premises telephony node 508 may directly connect calls between devices within the premises 502 without relying on the Internet 510 or other external networks.

As described above, the on-premises telephony node 508 is capable of processing VOIP calls for the on-premises devices (e.g., the video calling device 504 or the telephone 506) via the Internet 510. The on-premises telephony node 508 is also connected to an SBC 514. The SBC 514 processes audio communications (e.g., audio calls or the audio portion of video calls) via a PSTN 516. For example, the SBC 514 may leverage the PSTN 516 to connect the telephone 506 or the video calling device 504 to a station 518 outside the premises 502. The SBC 514 generates a CDR for each call processed via the PSTN 516 and stores the generated CDR in a CDR data repository 520 on the premises 502. The CDR data repository 520 may be accessible to at least one of regulators, telephone companies, or on-premises custodians for verifying compliance with PSTN calling requirements, best practices, or recommendations. The CDR data repository 520 stores representations of sessions leveraging connections via the PSTN 516.

As shown, different stations 512, 518 are accessible via the Internet 510 and via the PSTN 516. However, it should be noted that, in some cases, the same station may be accessed via the Internet 510 or the PSTN 516. For example, when making a telephone call from a station in New York City to a station in Washington, DC, the audio data of the telephone call can be transferred between the two stations via the Internet or via the PSTN.

In some cases, additional networks may be involved in processing the call. For example, a mobile phone might be connected to a cellular network and might require a cellular network to process the call, after the call reaches the destination location (e.g., associated with a country code or an area code of a telephone number) associated with the call. Alternatively, a wired phone might be connected only to the PSTN, and might require the call to be processed over the PSTN after the destination location is accessed via VOIP or via the PSTN. The Internet 510 (e.g., for VOIP calls) or the PSTN 516 (e.g., for PSTN calls) illustrated in FIG. 5 may be an initial network, among multiple networks, that are used for transmitting audio or video data from the on-premises telephony node 508 to the station 512, 518 outside the premises 502.

Implementations of the disclosed technology are performed at the on-premises telephony node 508. The on-premises telephony node 508 determines whether a call associated with a session initiation request received from the video calling device 504 or the telephone 506 is to be processed via the Internet 510 using VOIP technology or via the PSTN 516 by way of the SBC 514. To comply with legal requirements of some jurisdictions or best practices recommended by some PSTN service providers, the on-premises telephony node 508 determines whether the session initiation request is for an audio or video communication with an external station. An external station may include a station that is not on the premises 502 and not on another premises of the same entity as the entity associated with the premises 502. For example, a software company might have offices in San Francisco, New York City, and Boston, with telephones or video calling devices located in the San Francisco office, the New York City office, or the Boston office being internal stations, and telephones or video calling devices located outside those three offices being external stations.

The on-premises telephony node 508 determines a session type for a session corresponding to the session initiation request based on whether the session initiation request is associated with the audio or video communication with the external station (or with at least one external station if the session initiation request is for a session that includes multiple stations, for example, a conference call or a three-way call). If the session initiation request is for an audio session or a video session with an internal station, the session type is VOIP. If the session initiation request is for an audio session with an external station, the session type is PSTN. If the session initiation request is for a video session with an external station, then the session type corresponds to audio being transmitted over the PSTN 516 and imagery being transmitted over the Internet 510.

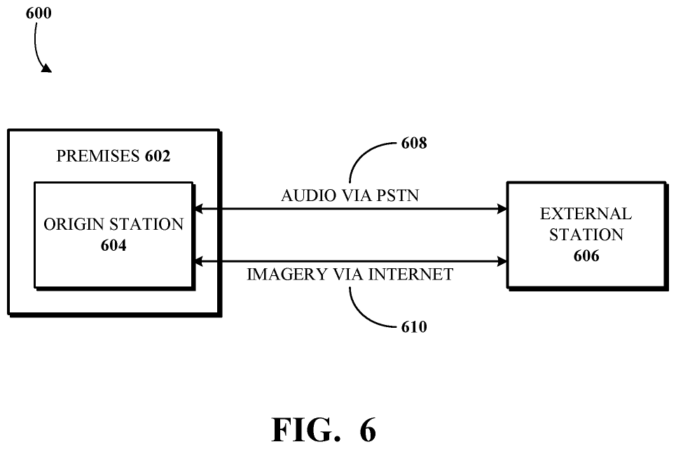

The on-premises telephony node 508 causes initiation of a session of the session type in accordance with the session initiation request. For example, if the session type is VOIP, the on-premises telephony node 508 connects to the station 512 to which the session is directed over the Internet 510. If the session type is PSTN, the on-premises telephony node 508 transmits a signal to the SBC 514. In response to the signal, the SBC 514 connects to the station 518 to which the session is directed over the PSTN 516. If the session type corresponds to audio being transmitted over the PSTN 516 and imagery being transmitted over the Internet 510, the on-premises telephony node 508 initiates an imagery transmission session with the destination station over the Internet 510 and an audio transmission session with the destination station over the PSTN 516. (As illustrated in FIG. 5, the Internet 510 connects to the station 512 and the PSTN 516 connects to the station 518. However, it should be noted that the imagery transmission session and the audio transmissions session may connect to the same destination station over different networks. An example is described in conjunction with FIG. 6.)

In one example use case, a user of a desk phone in the San Francisco office of a technology company telephones a desk phone in the New York City office of the same technology company. The on-premises telephony node 508 determines that the destination station of the telephone call (the desk phone in the New York City office of the technology company) is an internal station because it is located in an office of the same entity (the technology company) as the origination station (the desk phone in the San Francisco office). Thus, the call is routed using VOIP technology over the Internet 510.

In another example use case, the user of the desk phone in the San Francisco office of the technology company telephones a mobile phone with a Boston telephone number that is roaming in Toronto. The on-premises telephony node 508 determines that the destination station of the telephone call is an external station because it is not associated with one of the premises of the entity. As a result, the call is initially routed, by operation of the SBC 514, via the PSTN 516 to a cellular node in Boston. The cellular node in Boston then uses the cellular network to further route the call to the destination station (the mobile phone) that is roaming in Toronto. The routing of the call from Boston to Toronto is handled by the cellular network (or multiple cellular networks, including a first cellular network in the United States and a second cellular network in Canada). Thus, the user of the desk phone or the entity may be charged long distance charges by the telephone company to route the call from San Francisco to Boston, and the user of the mobile phone may be charged roaming charges due to their roaming in Toronto.

In yet another example use case, the user of the desk phone in the San Francisco office of the technology company telephones another desk phone in the San Francisco office. The other desk phone in the San Francisco office is an internal station because it is in the same premises as the desk phone that originated the call. The call may be routed directly by the on-premises telephony node 508 without relying on any external networks (e.g., the Internet 510 or the PSTN 516). As a result, that call may be completed if one or both of the external networks is unavailable. Example of video calling using the disclosed technology are described in conjunction with FIG. 6.

FIG. 6 is a block diagram of an example video calling system 600 which may, for example, use the telephone and video calling system 500 shown in FIG. 5. As shown, the system 600 includes a premises 602 that includes an origin station 604. The origin station initiates a video call to an external station 606. The premises 602 may correspond to the premises 502. The origin station 604 may correspond to the video calling device 504. The external station may be a station that is external to the premises 602 and other premises of an entity that owns, rents, leases, operates, or manages the premises 602. The external station may correspond to one of the stations 512, 518. As illustrated in FIG. 6, the video call between the origin station 604 and the external station 606 includes audio transmitted via the PSTN 608 and imagery transmitted via the Internet 610. In some cases, another suitable imagery transmission network may be used in addition to or in place of the Internet to transmit the imagery. The Internet may include an imagery transmission network. When the origin station 604 initiates the video call, a telephony node (e.g., the on-premises telephony node 508) generates a connection to the external station 606 over the Internet for bidirectional imagery transmission and instructs a SBC (e.g., the SBC 514) to initiate a PSTN call to the external station 606 for bidirectional audio transmission. This allows a telephone company facilitating PSTN calls to charge a long distance toll for the bidirectional audio transmission.

In one example use case, a user of a video calling device in the San Francisco office of a technology company initiates a video call to a mobile device with a Dallas telephone number. The on-premises telephony node of the premises of the technology company in San Francisco determines that the destination station (the mobile device with the Dallas telephone number) is an external station because the destination station is not associated with an office of the technology company. Thus, the on-premises telephony node transmits, to the on-premises SBC, a signal to initiate a PSTN audio call to the telephone number of the mobile device. The PSTN audio call is handled by a telephone company that provides PSTN access to the San Francisco office, and the telephone company is able to charge long distance tolls for the call. In parallel with initiating the PSTN audio call, the on-premises telephony node initiates an Internet-based connection for transmission of imagery between the video calling device in the San Francisco office and the mobile device with the Dallas telephone number. As a result, the imagery of the call is transmitted over the Internet (as the PSTN might not be configured for imagery transmission) while the audio of the call is transmitted over the PSTN.

In another example use case, the user of the video calling device in the San Francisco office of the technology company initiates a video call to a video calling device in the Boston office of the technology company. The on-premises telephony node in San Francisco determines that the destination station (the video calling device in Boston) is an internal station because the destination station is associated with one of the offices (the Boston office) of the technology company. Based on the determination that the destination station is the internal station, the on-premises telephony node determines that the video call may be performed over the Internet. Thus, the Internet is used for both the audio communication and the imagery communication of the video call.

In yet another example use case, the user of the video calling device in the San Francisco office of the technology company initiates a video call to another video calling device in the San Francisco office of the technology company. The on-premises telephony node determines that the destination device is an internal station (as the destination device is located on the premises, the premises being the San Francisco office) and that the call is internal to the San Francisco office and, thus, may be connected without relying on external networks, such as the Internet and the PSTN. The on-premises telephony node directly connects the video calling device to the other video calling device and facilitates direct transmission of both audio data an imagery between the devices in the video call.

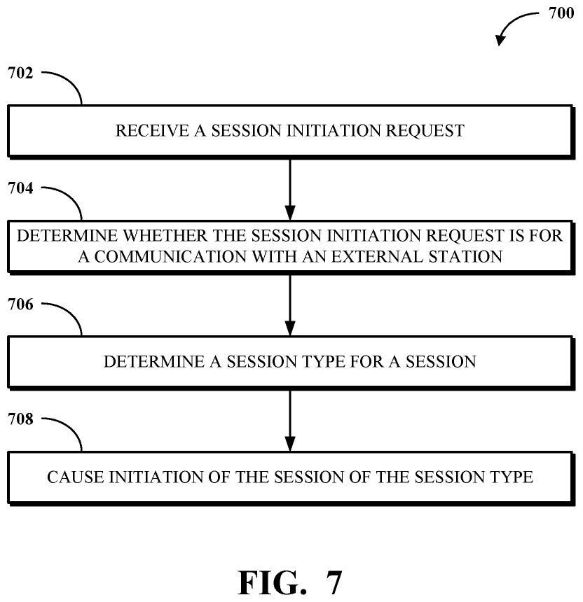

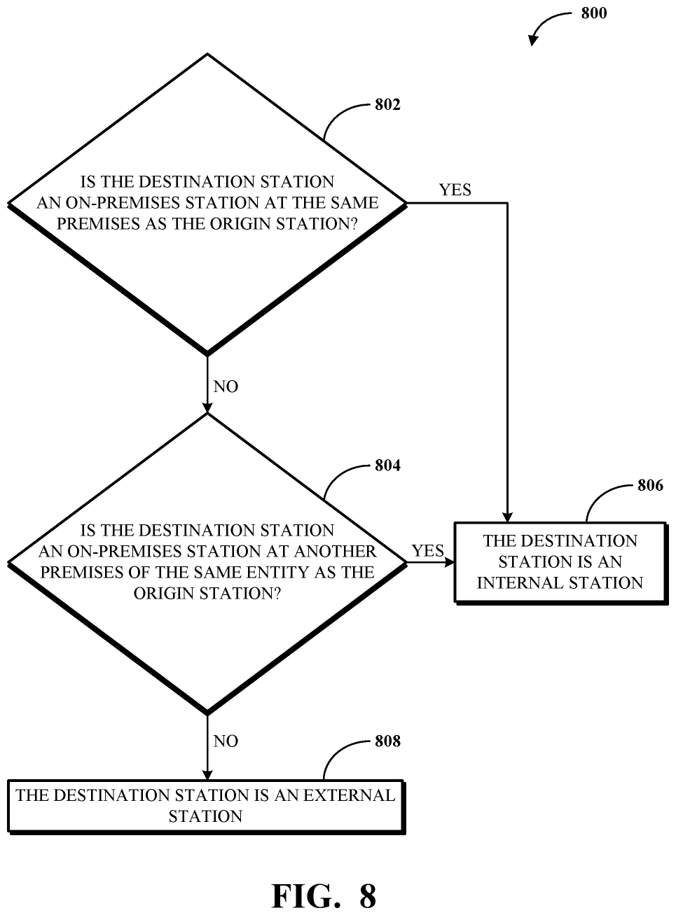

To further describe some implementations in greater detail, reference is next made to examples of techniques for network selection by telephony node. FIG. 7 is a flowchart of an example of a technique 700 for network selection via telephony node. FIG. 8 is a flowchart of an example of a technique 800 for determining whether a destination station is an internal station or an external station. The techniques 700 or 800 can be executed using computing devices, such as the systems, hardware, and software described with respect to FIGS. 1-6. The techniques 700 or 800 can be performed, for example, by executing a machine-readable program or other computer-executable instructions, such as routines, instructions, programs, or other code. The steps, or operations, of the techniques 700 or 800 or another technique, method, process, or algorithm described in connection with the implementations disclosed herein can be implemented directly in hardware, firmware, software executed by hardware, circuitry, or a combination thereof.

For simplicity of explanation, the techniques 700 and 800 are depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 7 illustrates the technique 700 for network selection via telephony node. The technique 700 may be performed at a telephony node, for example, the on-premises telephony node 508.

At 702, the telephony node receives a session initiation request from a device on a premises (e.g., the premises 502) of the telephony node. For example, the device may be the video calling device 504, the telephone 506, or another device connected to an internal network of the premises configured for audio or video communication. The internal network may be a wired or wireless network. The internal network may be a local area network (LAN).

At 704, the telephony node determines whether the session initiation request is for communication (e.g., audio or video communication) with an external station. An external station may be a station that is not on the premises and not on another premises associated with (e.g., belonging to) a same entity as the premises. An internal station may be a station that is on the premises or on another premises associated with the same entity as the premises.

At 706, the telephony node determines a session type for a session to be initiated in response to the session initiation request. The session type is determined based on whether the session initiation request is for communication with the external station. The session type may include at least one of a PSTN session or a VOIP session.

At 708, the telephony node causes initiation of a session of the session type in accordance with the session initiation request. In some cases, responsive to the session initiation request being associated with audio or video communication with the external station, the telephony node transmits, to a SBC (e.g., the SBC 514) on the premises, a signal to initiate the PSTN session with the external station for the audio communication. Responsive to the session initiation request being associated with video communication with the external station, the telephony node uses the PSTN session with the external station to process audio of the video communication. The telephony node causes transmission of imagery between the device and the external station via a network (e.g., the Internet) different from the PSTN.

Responsive to the session initiation request not being associated with the audio or video communication with the external station (e.g., the session initiation request being associated with audio or video communication with an internal station), the telephony node initiates the VOIP session corresponding to the session initiation request. During the VOIP session, audio and/or imagery may be transmitted over a network different from the PSTN. The network different from the PSTN may be the Internet.

As described above, if the session type is the VOIP session, the telephony node initiates the VOIP session. If the session type is the PSTN session, the telephony node transmits, to the SBC on the premises, the signal to initiate the PSTN session. The SBC initiates the PSTN session in response to the signal.

FIG. 8 illustrates the technique 800 for determining whether a destination station is an internal station or an external station. The destination station may be a device corresponding to a telephone number that was dialed or a device logged in to an account associated with a user identifier to which a video call is directed. Similarly to the technique 700, the technique 800 may be performed at a telephony node, for example, the on-premises telephony node 508.

At 802, the telephony node determines whether the destination station is an on-premises station at the same premises as an origin station from which the telephone call or the video call was placed. For example, the telephony node may consult a directory of stations that are on the premises. The directory may include static entries (e.g., desk phones or fixed video calling devices, such as conference room devices) and dynamic entries (e.g., a mobile device of an employee that is configured to receive video calls may be determined to be on the premises when it is connected to a network (e.g., a wireless network) of the premises and may be determined to be off the premises when it is not connected to the network of the premises). The directory may be stored at the telephony node or at a data repository with which the telephony node is configured to communicate (e.g., via a network). If the telephony node determines that the destination station is not the on-premises station at the same premises as the origin station, the technique 800 continues to 804. If the telephony node determines that the destination station is the on-premises station at the same premises as the origin station, the technique 800 continues to 806.

At 804, the telephony node determines whether the destination station is an on-premises station at another premises of the same entity as the origin station. Other premises of the same entity may include, for example, other homes owned by the same homeowner or other offices of the same business or other organization. Similarly to the above, the telephony node may consult a directory of on-premises stations for the other premises of the entity to determine whether the destination station is the on-premises station at one of the other premises. As described above, the directory may include static entries and dynamic entries. The dynamic entries may correspond to mobile devices that are sometimes in one of the premises of the entity (and connected to a network of the entity) and sometimes outside all of the premises of the entity (and not connected to any of the entity's networks). The mobile devices would be considered on-premises when connected to the network of the entity and off-premises otherwise. If the destination station is determined to be the on-premises station at the premises of the same entity as the origin station, the technique 800 continues to 806. Otherwise, the technique 800 continues to 808.

In some cases, the entity only has a single premises (e.g., a business may have a single office). In these cases, the destination station is definitely not an on-premises station at another premises of the same entity as the origin station. Thus, if 804 is reached, the technique 800 continues to 808 as the destination station is not the on-premises station at another premises of the same entity.

At 806, in response to determining either that the destination station is the on-premises station at the same premises as the origin station or that the destination station is the on-premises station at another premises of the same entity as the origin station, the telephony node determines that the destination station is the internal station. As a result, VOIP may be used for audio communication with the destination station.

At 808, in response to determining either that the destination station is not the on-premises station at the same premises as the origin station and that the destination station is not the on-premises station at another premises of the same entity as the origin station, the telephony node determines that the destination station is the external station. As a result, the PSTN may be used for audio communication with the destination station. For video calls, imagery may still be transmitted over a network different from the PSTN, such as the Internet.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

Some implementations are described below as numbered examples (Example 1, 2, 3, etc.). These examples are provided as examples only and do not limit the other implementations disclosed herein.

Example 1 is a method, comprising: determining whether a session initiation request, received at an on-premises telephony node, is associated with audio or video communication with an external station; determining a session type for a session based on whether the session initiation request is associated with the audio or video communication with the external station, the session type comprising at least one of a public switched telephone network (PSTN) session or a Voice over Internet Protocol (VOIP) session; and causing initiation of the session based on the determination of the session type.

In Example 2, the subject matter of Example 1 includes, wherein determining the session type and causing initiation of the session comprises: responsive to the session initiation request being associated with the audio or video communication with the external station, transmitting, to an on-premises session border controller coupled with the on-premises telephony node, a signal to initiate the PSTN session with the external station for the audio communication.

In Example 3, the subject matter of Examples 1-2 includes, wherein determining the session type and causing initiation of the session comprises: responsive to the session initiation request not being associated with the audio or video communication with the external station, initiating, by the on-premises telephony node, the VOIP session corresponding to the session initiation request.

In Example 4, the subject matter of Examples 1-3 includes, wherein determining the session type and causing initiation of the session comprises: responsive to the session initiation request being associated with the video communication with the external station: using the PSTN session with the external station to process audio of the video communication; and causing transmission of imagery to or from the external station via a network different from that of the PSTN session.

In Example 5, the subject matter of Examples 1-4 includes, storing, at an on-premises data repository coupled with an on-premises session border controller, a call detail record generated by the on-premises session border controller, the call detail record comprising representations of sessions having the session type of the PSTN session.

In Example 6, the subject matter of Examples 1-5 includes, wherein the external station is not an on-premises station residing on one of multiple premises associated with an entity hosting the on-premises telephony node.

In Example 7, the subject matter of Examples 1-6 includes, wherein the external station is not an on-premises station residing on a premises associated with an entity hosting the on-premises telephony node.

Example 8 is a non-transitory computer readable medium storing instructions operable to cause one or more processors to perform operations comprising: determining whether a session initiation request, received at an on-premises telephony node, is associated with audio or video communication with an external station; determining a session type for a session based on whether the session initiation request is associated with the audio or video communication with the external station, the session type comprising at least one of a public switched telephone network (PSTN) session or a Voice over Internet Protocol (VOIP) session; and causing initiation of the session based on the determination of the session type.

In Example 9, the subject matter of Example 8 includes, wherein determining the session type and causing initiation of the session comprises: responsive to the session initiation request being associated with the audio or video communication with the external station, transmitting, to an on-premises session border controller coupled with the on-premises telephony node, a signal to initiate the audio communication with the external station via PSTN.

In Example 10, the subject matter of Examples 8-9 includes, wherein determining the session type and causing initiation of the session comprises: responsive to the session initiation request not being associated with the audio or video communication with the external station, initiating the VOIP session corresponding to the session initiation request.

In Example 11, the subject matter of Examples 8-10 includes, wherein determining the session type and causing initiation of the session comprises: responsive to the session initiation request being associated with the video communication with the external station: processing audio of the video communication using the PSTN session with the external station; and causing transmission of imagery to or from the external station via a network different from that of the PSTN session.

In Example 12, the subject matter of Examples 8-11 includes, the operations comprising: storing a call detail record generated by the on-premises session border controller, the call detail record comprising representations of sessions having the session type of the PSTN session.

In Example 13, the subject matter of Examples 8-12 includes, wherein the external station is not connected to a network of on one of multiple premises associated with an entity hosting the on-premises telephony node.

In Example 14, the subject matter of Examples 8-13 includes, wherein the external station is not connected to a network of a premises associated with an entity hosting the on-premises telephony node.

Example 15 is a system, comprising: a memory subsystem; and processing circuitry configured to execute instructions stored in the memory subsystem to: determine whether a session initiation request, received at an on-premises telephony node, is associated with audio or video communication with an external station; determine a session type for a session based on whether the session initiation request is associated with the audio or video communication with the external station, the session type comprising at least one of a public switched telephone network (PSTN) session or a Voice over Internet Protocol (VOIP) session; and cause initiation of the session based on the determination of the session type.

In Example 16, the subject matter of Example 15 includes, wherein determining the session type and causing initiation of the session comprises: responsive to the session initiation request being associated with the audio or video communication with the external station, causing an on-premises session border controller to initiate the PSTN session with the external station for the audio communication.

In Example 17, the subject matter of Examples 15-16 includes, wherein determining the session type and causing initiation of the session comprises: responsive to the session initiation request not being associated with the audio or video communication with the external station, initiating, by the on-premises telephony node, the VOIP session in accordance with the session initiation request.

In Example 18, the subject matter of Examples 15-17 includes, wherein determining the session type and causing initiation of the session comprises: responsive to the session initiation request being associated with the video communication with the external station: using the PSTN session with the external station to process audio of the video communication; and causing transmission of imagery to or from the external station via an imagery transmission network, wherein the imagery transmission network is different from that of the PSTN session.

In Example 19, the subject matter of Examples 15-18 includes, the processing circuitry configured to execute instructions stored in the memory subsystem to: store, at an on-premises data repository coupled with an on-premises session border controller, call detail records representing sessions having the session type of the PSTN session.

In Example 20, the subject matter of Examples 15-19 includes, wherein the external station is not an on-premises station residing on one of multiple premises associated with an entity hosting the on-premises telephony node, and wherein the external station is not an on-premises station residing on a premises associated with an entity hosting the on-premises telephony node.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
determining whether a session initiation request, received at an on-premises telephony node, is associated with audio or video communication with an external station;
determining a session type for a session based on whether the session initiation request is associated with the audio or video communication with the external station, the session type comprising at least one of a public switched telephone network (PSTN) session or a Voice over Internet Protocol (VOIP) session; and
causing initiation of the session based on the determination of the session type.

2. The method of claim 1, wherein determining the session type and causing initiation of the session comprises:
responsive to the session initiation request being associated with the audio or video communication with the external station, transmitting, to an on-premises session border controller coupled with the on-premises telephony node, a signal to initiate the PSTN session with the external station for the audio communication.

3. The method of claim 1, wherein determining the session type and causing initiation of the session comprises:
responsive to the session initiation request not being associated with the audio or video communication with the external station, initiating, by the on-premises telephony node, the VoIP session corresponding to the session initiation request.

4. The method of claim 1, wherein determining the session type and causing initiation of the session comprises:
responsive to the session initiation request being associated with the video communication with the external station:
using the PSTN session with the external station to process audio of the video communication; and
causing transmission of imagery to or from the external station via a network different from that of the PSTN session.

5. The method of claim 1, comprising:
storing, at an on-premises data repository coupled with an on-premises session border controller, a call detail record generated by the on-premises session border controller, the call detail record comprising representations of sessions having the session type of the PSTN session.

6. The method of claim 1, wherein the external station is not an on-premises station residing on one of multiple premises associated with an entity hosting the on-premises telephony node.

7. The method of claim 1, wherein the external station is not an on-premises station residing on a premises associated with an entity hosting the on-premises telephony node.

8. A non-transitory computer readable medium storing instructions operable to cause one or more processors to perform operations comprising:
determining whether a session initiation request, received at an on-premises telephony node, is associated with audio or video communication with an external station;
determining a session type for a session based on whether the session initiation request is associated with the audio or video communication with the external station, the session type comprising at least one of a public switched telephone network (PSTN) session or a Voice over Internet Protocol (VOIP) session; and
causing initiation of the session based on the determination of the session type.

9. The non-transitory computer readable medium of claim 8, wherein determining the session type and causing initiation of the session comprises:
responsive to the session initiation request being associated with the audio or video communication with the external station, transmitting, to an on-premises session border controller coupled with the on-premises telephony node, a signal to initiate the audio communication with the external station via PSTN.

10. The non-transitory computer readable medium of claim 8, wherein determining the session type and causing initiation of the session comprises:
responsive to the session initiation request not being associated with the audio or video communication with the external station, initiating the VOIP session corresponding to the session initiation request.

11. The non-transitory computer readable medium of claim 8, wherein determining the session type and causing initiation of the session comprises:
responsive to the session initiation request being associated with the video communication with the external station:
processing audio of the video communication using the PSTN session with the external station; and
causing transmission of imagery to or from the external station via a network different from that of the PSTN session.

12. The non-transitory computer readable medium of claim 8, the operations comprising:
storing a call detail record generated by the on-premises session border controller, the call detail record comprising representations of sessions having the session type of the PSTN session.

13. The non-transitory computer readable medium of claim 8, wherein the external station is not connected to a network of on one of multiple premises associated with an entity hosting the on-premises telephony node.

14. The non-transitory computer readable medium of claim 8, wherein the external station is not connected to a network of a premises associated with an entity hosting the on-premises telephony node.

15. A system, comprising:
a memory subsystem; and
processing circuitry configured to execute instructions stored in the memory subsystem to:
determine whether a session initiation request, received at an on-premises telephony node, is associated with audio or video communication with an external station;
determine a session type for a session based on whether the session initiation request is associated with the audio or video communication with the external station, the session type comprising at least one of a public switched telephone network (PSTN) session or a Voice over Internet Protocol (VOIP) session; and
cause initiation of the session based on the determination of the session type.

16. The system of claim 15, wherein determining the session type and causing initiation of the session comprises:
responsive to the session initiation request being associated with the audio or video communication with the external station, causing an on-premises session border controller to initiate the PSTN session with the external station for the audio communication.

17. The system of claim 15, wherein determining the session type and causing initiation of the session comprises:
responsive to the session initiation request not being associated with the audio or video communication with the external station, initiating, by the on-premises telephony node, the VoIP session in accordance with the session initiation request.

18. The system of claim 15, wherein determining the session type and causing initiation of the session comprises:
responsive to the session initiation request being associated with the video communication with the external station:
using the PSTN session with the external station to process audio of the video communication; and
causing transmission of imagery to or from the external station via an imagery transmission network, wherein the imagery transmission network is different from that of the PSTN session.

19. The system of claim 15, the processing circuitry configured to execute instructions stored in the memory subsystem to:
store, at an on-premises data repository coupled with an on-premises session border controller, call detail records representing sessions having the session type of the PSTN session.

20. The system of claim 15, wherein the external station is not an on-premises station residing on one of multiple premises associated with an entity hosting the on-premises telephony node, and wherein the external station is not an on-premises station residing on a premises associated with an entity hosting the on-premises telephony node.
